(19) United States
(12) Patent Application Publication
(10) Pub. No.: US 2008/0307652 A1
(43) Pub. Date: Dec. 18, 2008

(54) Method For Manufacturing Bicycle Crank

(76) Inventor: Douglas Chiang, Taipei (TW)

Correspondence Address: Douglas CHIANG, 235 Chung-Ho Box 8-24, Taipei, TW

(21) Appl. No.: 11/762,753

(22) Filed: Jun. 13, 2007

(51) Int. Cl. B21D 53/86; B29C 70/86

(52) U.S. Cl. 29/897.2; 156/172; 264/515

(57) ABSTRACT

A method for manufacturing a bicycle crank, comprises the steps of: blowing air into a blowing opening at a lower end of a backbone so as to fixing the backbone; wherein the backbone has a first embedding portion; using a cutter to cut the backbone; and then form a second embedding portion in the end of the backbone having the blowing opening; winding an unidirectional carbon-fiber cloth around the backbone; adhering carbon-fiber adhesive sheet upon an outer side of the backbone; and heating the backbone so as to firmly secure the carbon-fiber adhesive sheet to the backbone. Furthermore before the blowing step, the method further comprises a step of forming a first embedding portion at one end of the backbone; and embedding a metal first tube into the first embedding portion.

### FIELD OF THE INVENTION

The present invention relates to bicycle cranks, and particularly to a method for manufacturing a bicycle crank, wherein small area carbon-fiber adhesive sheets are added to the crank so as to have a preferred strength with less cost and less work.

### BACKGROUND OF THE INVENTION

It is a current trend to use carbon-fiber composite material to make parts of a bicycle.

For a crank of a bicycle made of carbon-fiber material, each of two ends of the crank must be connected to a five communication tube. However, the carbon-fiber composite material is very hard and brittle. Thus the connections therebetween are not effective. To strengthen the structure, the pivoted areas are buried with metal tubes. Further small area carbon-fiber adhesive sheets are adhered upon the crank one by one. Then metal tubes are engaged to the crank. Finally, gluing adhesives are planted upon the crank so as to complete the process of making a crank.

However, the prior art has some troubles in manufacturing and generates some defects in the products. In adhering small area carbon-fiber adhesive sheets upon the crank one by one, the plane carbon-fiber adhesive sheets are difficult in manufacturing. Not only time is consumed, but also it must be performed by professional persons. The cost is high. Furthermore the interior of the crank must be formed with supporting blocks for adhering operation, and thus it is not a complete hollow structure. The material needed is grater and thus heavy.

When the crank is complete, the metal tubes are buried. However, the combination of the crank with the two tubes is not concrete. Adhesive is used to enhance the structure. However, adhesive generates the problems of buckling and the difficulty in prepare. Thus, the prior art is not practical and is necessary to be improved.

### SUMMARY OF THE INVENTION

Accordingly, the primary object of the present invention is to provide a method for manufacturing a bicycle crank, wherein small area carbon-fiber adhesive sheets are added to the crank so as to have preferred strength with less cost and less work.

To achieve above objects, the present invention provides a method for manufacturing a bicycle crank, comprising the steps of: blowing air into a blowing opening at a lower end of a backbone so as to fixing the backbone; wherein the backbone has a first embedding portion; using a cutter to cut the backbone; and then form a second embedding portion in the end of the backbone having the blowing opening; winding an unidirectional carbon-fiber cloth around the backbone; adhering carbon-fiber adhesive sheet upon an outer side of the backbone; and heating the backbone so as to firmly secure the carbon-fiber adhesive sheet to the backbone. Furthermore before the blowing step, the method further comprises a step of forming a first embedding portion at one end of the backbone; and embedding a metal first tube into the first embedding portion.

The various objects and advantages of the present invention will be more readily understood from the following detailed description when read in conjunction with the appended drawing.

### BRIEF DESCRIPTION OF THE DRAWINGS

FIG. 1 shows the flow diagram of the present invention.

FIGS. 2 and 3 are schematic views showing the steps of embedding tubes to the backbone according to the present invention.

FIG. 4 is a schematic view showing the step of cutting according to the present invention.

FIGS. 5, 6 and 7 are schematic view showing the steps of winding the carbon-fiber cloth according to the present invention.

FIG. 8 is a schematic view showing the product of the present invention.

FIG. 9 is a schematic cross sectional view along line AB of the present invention.

FIG. 10 is a schematic view showing the perspective view of the present invention.

FIG. 11 is a flow diagram of the second embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

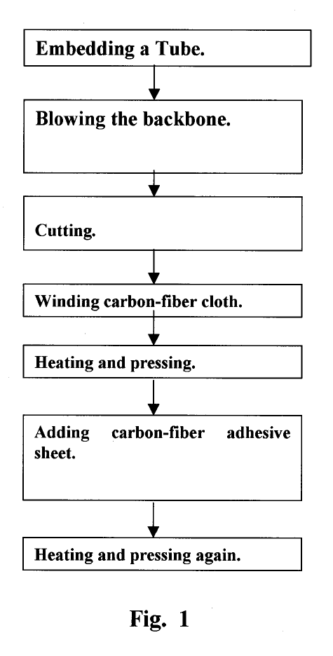

With reference to FIG. 1, the method for manufacturing a crank of a bicycle according to the present invention is illustrated. The present invention has the following steps of:

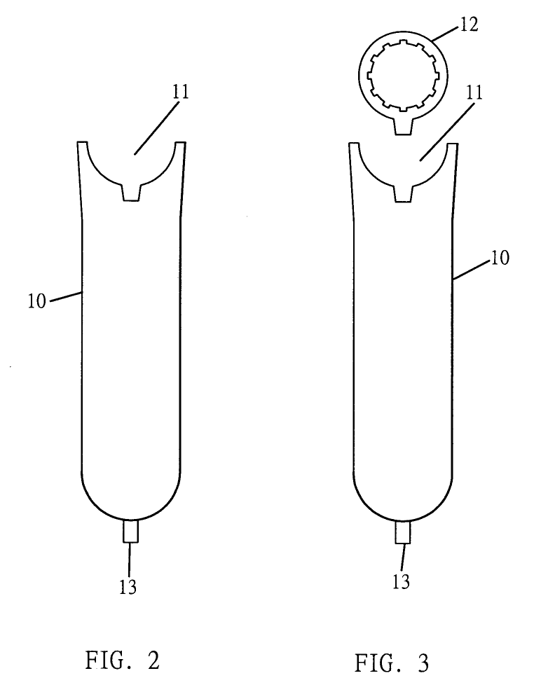

Referring to FIGS. 1 and 2, taking a hollow fiber backbone 10 as an initial assembly of a crank; forming a first embedding portion 11 at one end of the backbone 10; and embedding a metal first tube 12 into the first embedding portion 11 (step 1);

Blowing air into a blowing opening 13 at a lower end of the hollow backbone 10 so as to fixing the first tube 12 to the backbone 10 (step 2);

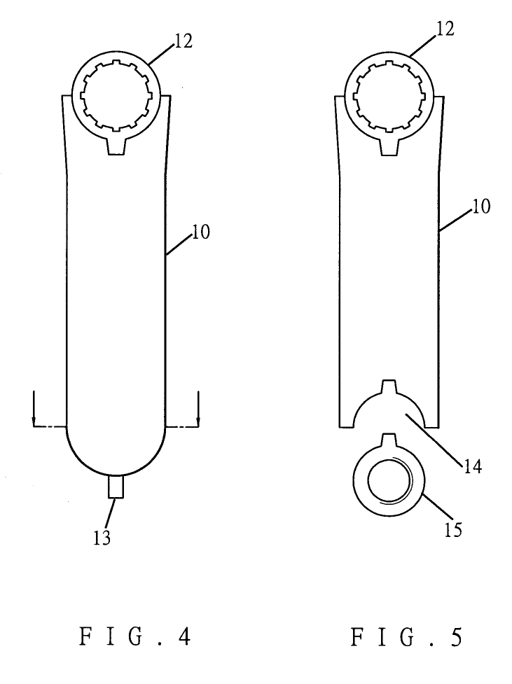

Referring to FIG. 4, using a cutter to cut the blowing opening 13 from the backbone 10; and then form a second embedding portion 14 in the end of the backbone 10 having the blowing opening 13; in that the cutter is for example a water jet (step 3);

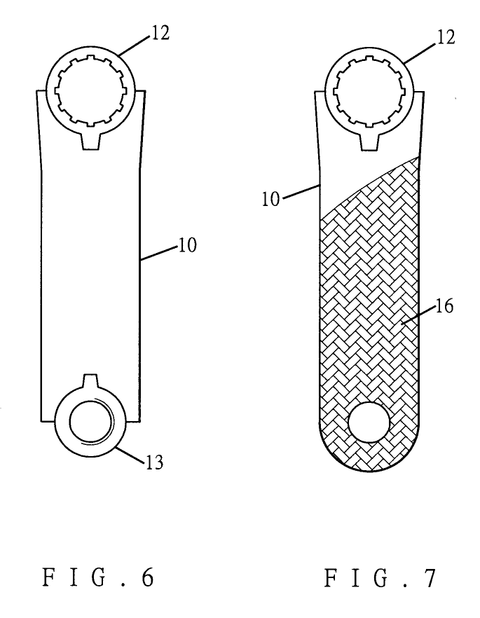

Referring to FIGS. 5 to 7, embedding a metal second tube 15 into the second embedding portion 14; winding an unidirectional carbon-fiber cloth 16 around the backbone 10, first tube 12 and second tube 15 so as to have a preferred combinational strength (step 4);

Thermally setting and pressing the backbone 10 so that the carbon-fiber cloth 16, first tube 12 and second tube 15 and the backbone 10 are combined firmly (step 5);

Adhering carbon-fiber adhesive sheet upon an outer side of the backbone 10 (step 6);

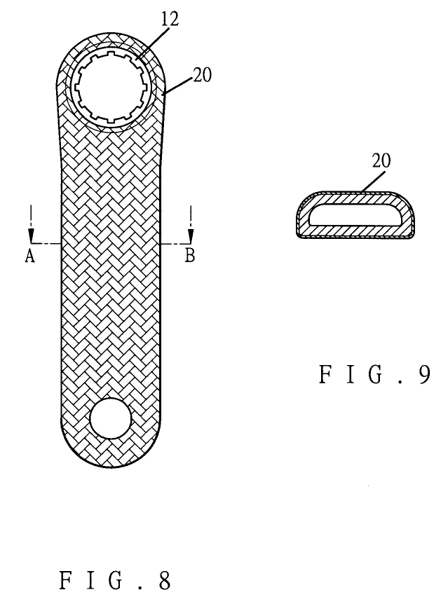

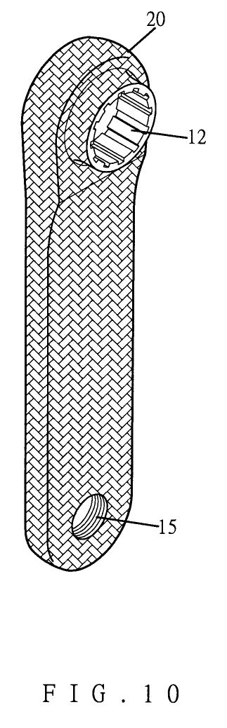

Heating the backbone 10 so as to firmly secure the carbon-fiber adhesive sheet to the backbone 10 (step 7); thus the product according to the present invention is complete as illustrated in FIGS. 8 to 10. The crank 20 has a hollow structure. It is lighter and the structure of the tubes and the crank 20 are preferred. The step for adhering the carbon-fiber adhesive sheet is very easy and simple.

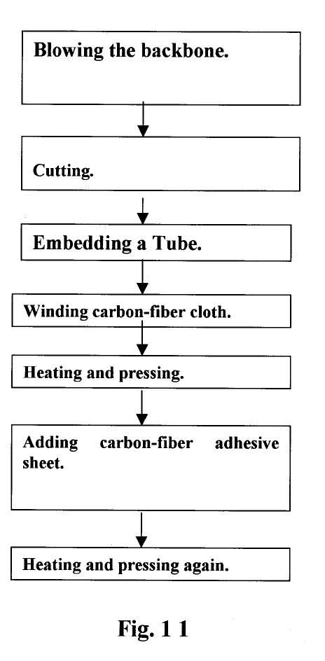

Referring to FIG. 11, the second embodiment of the present invention is illustrated. In this embodiment, those identical to the above mentioned embodiment will not be further described herein. Only those difference are disclosed. In this the present invention, the step for embedding the first tube 12 and second tube 15 are delayed to be after the step of cutting the backbone 10 by using the cutter. All these steps are within the steps of the present invention.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for manufacturing a bicycle crank, comprising the steps of:
blowing air into a blowing opening at a lower end of a backbone so as to fix the backbone; wherein the backbone has a first embedding portion;
using a cutter to cut the backbone; and then forming a second embedding portion in the end of the backbone having the blowing opening;
winding an unidirectional carbon-fiber cloth around the backbone;
adhering carbon-fiber adhesive sheet upon an outer side of the backbone; and
heating the backbone so as to firmly secure the carbon-fiber adhesive sheet to the backbone.

2. The method for manufacturing a bicycle crank as claimed in claim 1, before the blowing step, further comprising a step of forming a first embedding portion at one end of the backbone; and embedding a metal first tube into the first embedding portion.

3. The method for manufacturing a bicycle crank as claimed in claim 2, before the winding step, further comprising a step of forming a second embedding portion at another end of the backbone; and embedding a metal second tube into the second embedding portion.

4. The method for manufacturing a bicycle crank as claimed in claim 1, before the winding step, further comprising a step of forming a first embedding portion at one end of the backbone; and embedding a metal first tube into the first embedding portion.

5. The method for manufacturing a bicycle crank as claimed in claim 4, after embedding the first tube, further comprising a step of forming a second embedding portion at another end of the backbone; and embedding a metal second tube into the first embedding portion.

6. The method for manufacturing a bicycle crank as claimed in claim 1, wherein before the adhering step, further comprising a step of heating the backbone to cause the carbon-fiber cloth is firmly secured to the backbone.

7. The method for manufacturing a bicycle crank as claimed in claim 1, wherein the carbon-fiber cloth is a uni-directional carbon-fiber cloth.

8. The method for manufacturing a bicycle crank as claimed in claim 1, wherein the backbone has a hollow structure.

9. The method for manufacturing a bicycle crank as claimed in claim 1, wherein a bottom of the backbone has a blowing opening.

10. The method for manufacturing a bicycle crank as claimed in claim 4, wherein a bottom of the backbone has a blowing opening.

11. The method for manufacturing a bicycle crank as claimed in claim 1, wherein the cutting is performed by a water jet.
